(19) United States
(12) Patent Application Publication
(10) Pub. No.: US 2026/0254494 A1
(43) Pub. Date: Aug. 27, 2026

(54) BEAM CONFIGURATIONS IN JOINT TIME AND PHASE ARRAYS

(71) Applicant: Samsung Electronics Co., Ltd., Suwon-si (KR)

(72) Inventors: Ahmad AlAmmouri, Plano, TX (US); Young Han Nam, Plano, TX (US)

(21) Appl. No.: 19/542,511

(22) Filed: Feb. 17, 2026

Related U.S. Application Data
(60) Provisional application No. 63/764,484, filed on Feb. 27, 2025.

(51) Int. Cl. H04B 7/06

(52) U.S. Cl. CPC H04B 7/0617

(57) ABSTRACT

Apparatuses and methods for beamforming for joint phase-time arrays (JPTAs). In some embodiments, a method for operating a base station (BS) is provided. The method includes receiving a first value by at least one beamforming integrated circuit (BFIC) and receiving a second value by at least one time delay integrated circuit (TDIC). The method further includes configuring, by the at least one BFIC, a phase shift generated by at least one phase shifter based on the first value, configuring, by the at least one TDIC, a time delay generated by at least one time delay unit based on the second value, and generating one or more beams for JPTA based on the configured phase shift and time delay.

### CROSS-REFERENCE TO RELATED APPLICATION(S) AND CLAIM OF PRIORITY

This application claims priority under 35 U.S.C. § 119(e) to U.S. Provisional Patent Application No. 63/764,484 filed on Feb. 27, 2025. The above-identified provisional patent application is hereby incorporated by reference in its entirety.

### TECHNICAL FIELD

This disclosure relates generally to wireless networks. More specifically, this disclosure relates to apparatuses and methods for beamforming for joint phase-time arrays (JPTAs).

### BACKGROUND

As wireless communication has grown and the number of subscribers to wireless communication services continues to grow quickly, the demand for wireless data traffic is rapidly increasing due to the growing popularity among consumers and businesses. To meet the high growth in mobile data traffic and support new applications and deployments, improvements in radio interface efficiency and coverage are of paramount importance. Moreover, this demand for wireless data traffic has increased since the deployment of 4G communication systems, and to enable various vertical applications, 5G (e.g., fifth generation) communication systems have been developed and are currently being deployed. Several characteristics of such applications have also been considered.

### SUMMARY

This disclosure provides apparatuses and methods for beam configurations in JPTAs.

In one embodiment, a method for operating a base station (BS) is provided. The method includes receiving a first value by at least one beamforming integrated circuit (BFIC) and receiving a second value by at least one time delay integrated circuit (TDIC). The method further includes configuring, by the at least one BFIC, a phase shift generated by at least one phase shifter based on the first value, configuring, by the at least one TDIC, a time delay generated by at least one time delay unit based on the second value, and generating one or more beams for JPTAs based on the configured phase shift and time delay.

In another embodiment, a BS is provided. The BS includes at least one BFIC configured to receive a first value and configure a phase shift generated by at least one phase shifter based on the first value. The BS further includes at least one TDIC configured to receive a second value and configure a time delay generated by at least one time delay unit based on the second value. The BS is configured to generate one or more beams for JPTA based on the configured phase shift and time delay.

In another embodiment, a non-transitory computer readable medium including program code is provided that when executed by processing circuitry of a BS causes the BS to receive a first value by at least one BFIC and a second value by at least one TDIC. The program code further causes the BS to configure, by the at least one BFIC, a phase shift generated by at least one phase shifter based on the first value, configure, by the at least one TDIC, a time delay generated by at least one time delay unit based on the second value, and generate one or more beams for JPTAs based on the configured phase shift and time delay.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to the present disclosure;

FIG. 3A illustrates an example UE according to the present disclosure;

FIG. 3B illustrates an example gNB according to the present disclosure;

FIG. 4 illustrates an example beamforming architecture that may be used in connection with either hybrid beamforming for O-RAN fronthaul or transmission of control information over O-RAN fronthaul for JPTAs according to the present disclosure;

FIG. 5 illustrates a diagram of an example phase-shifter based frequency-flat hybrid beamforming according to embodiments of the present disclosure;

FIG. 6 illustrates an example of a JPTA beamforming on a beam set according to various embodiments of the present disclosure;

FIG. 7 illustrates a diagram of an example JPTA circuit according to embodiments of the present disclosure;

FIG. 8 illustrates an example of a JPTA beam pattern is for a 2D beam pattern for JPTA discrete-angle beam according to embodiments of the present disclosure;

FIG. 9 illustrates an example radio frequency front end interface (RFEE) used in phase-array beamforming according to embodiments of the present disclosure;

FIG. 10 illustrates an example RFEE used in JPTA beamforming according to embodiments of the present disclosure;

FIG. 11 illustrates an example RFEE used in JPTA beamforming according to embodiments of the present disclosure;

FIG. 12 illustrates an example RFEE used in JPTA beamforming according to embodiments of the present disclosure;

FIG. 13 illustrates an example RFEE used in JPTA beamforming according to embodiments of the present disclosure; and

FIG. 14 illustrates a flowchart for an example method for performing JPTA beamforming according to an embodiment of the present disclosure.

### DETAILED DESCRIPTION

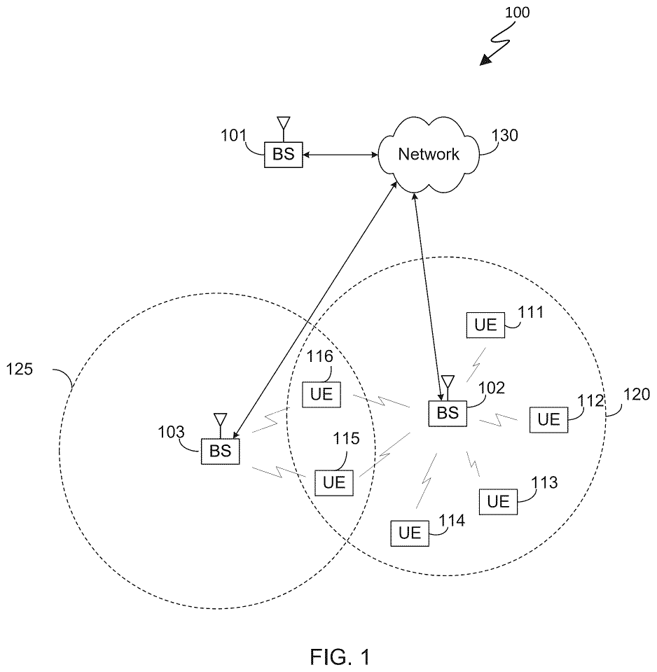

FIGS. 1-14, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since the deployment of 4G communication systems, efforts have been made to develop an improved 5G or pre-5G communication system. Therefore, the 5G or pre-5G communication system is also called a “beyond 4G network” or a “post LTE system.”

The 5G communication system is implemented in higher frequency (mmWave) bands, e.g., 60 GHz bands, to accomplish higher data rates. To decrease propagation loss of the radio waves and increase the transmission coverage, the beamforming, massive multiple-input multiple-output (MIMO), full dimensional MIMO (FD-MIMO), array antenna, an analog beam forming, large scale antenna techniques and the like are discussed in 5G communication systems.

In addition, in 5G communication systems, development for system network improvement is underway based on advanced small cells, cloud radio access networks (RANs), ultra-dense networks, device-to-device (D2D) communication, wireless backhaul communication, moving network, cooperative communication, coordinated multi-points (COMP) transmission and reception, interference mitigation and cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and non-limiting embodiments of the present disclosure may be utilized in connection with any frequency band. For example, aspects of the present disclosure may also be applied to the deployment of 5G communication systems, 6G or even later releases which may use terahertz (THz) bands.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or another data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 include circuitry, programing, or a combination thereof to utilize beam configurations in JPTAs.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

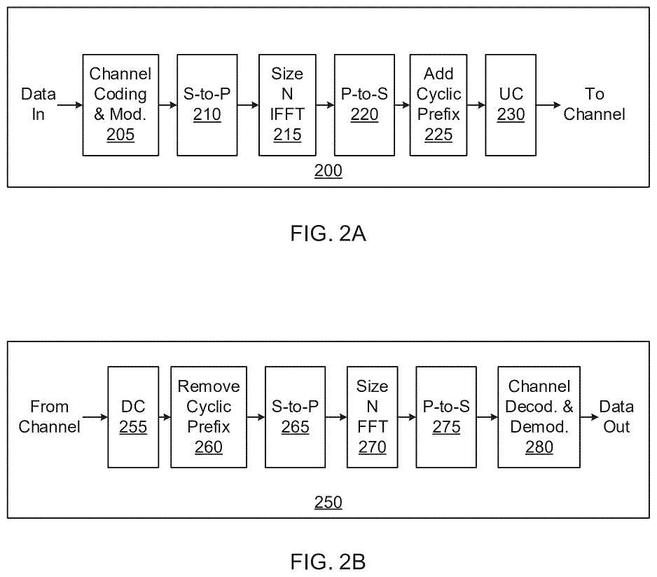

FIGS. 2A and 2B illustrate example wireless transmit and receive paths according to the present disclosure. In the following description, a transmit path 200 can be described as being implemented in a gNB (such as gNB, or base station (BS), 102), while a receive path 250 can be described as being implemented in a UE (such as UE 116). However, it will be understood that the receive path 250 could be implemented in a gNB and that the transmit path 200 could be implemented in a UE. In some embodiments, the transmit path 200 is configured to utilize beam configurations in JPTAs as described in various embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an ‘add cyclic prefix’ block 225, and an up-converter (UC) 230. The receive path 250 includes a down-converter (DC) 255, a ‘remove cyclic prefix’ block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as convolutional, Turbo, or low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The S-to-P block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The P-to-S block 220 converts (such as multiplexes) the parallel time-domain output symbols from the size N IFFT block 215 in order to generate a serial time-domain signal. The ‘add cyclic prefix’ block 225 inserts a cyclic prefix to the time-domain signal. The UC 230 modulates (such as up-converts) the output of the ‘add cyclic prefix’ block 225 to an RF frequency for transmission via a wireless channel. The signal can also be filtered at baseband before conversion to the RF frequency.

A transmitted RF signal from the gNB 102 arrives at the UE 116 after passing through the wireless channel, and reverse operations to those at the gNB 102 are performed at the UE 116. The DC 255 down-converts the received signal to a baseband frequency, and the ‘remove cyclic prefix’ block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 can implement a transmit path 200 that is analogous to transmitting in the downlink to UEs 111-116 and can implement a receive path 250 that is analogous to receiving in the uplink from UEs 111-116. Similarly, each of UEs 111-116 can implement a transmit path 200 for transmitting in the uplink to gNBs 101-103 and can implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B can be implemented in software, while other components can be implemented by configurable hardware or a mixture of software and configurable hardware. For instance, the FFT block 270 and the IFFT block 215 can be implemented as configurable software algorithms, where the value of size N can be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, could be used. It will be appreciated that the value of the variable N can be any integer number (such as 1, 2, 3, 4, or the like) for DFT and IDFT functions, while the value of the variable N can be any integer number that is a power of two (such as 1, 2, 4, 8, 16, or the like) for FFT and IFFT functions.

Although FIGS. 2A and 2B illustrate examples of wireless transmit and receive paths, various changes can be made to FIGS. 2A and 2B. For example, various components in FIGS. 2A and 2B could be combined, further subdivided, or omitted, and additional components could be added according to particular needs. Also, FIGS. 2A and 2B are meant to illustrate examples of the types of transmit and receive paths that could be used in a wireless network. Other suitable architectures could be used to support wireless communications in a wireless network.

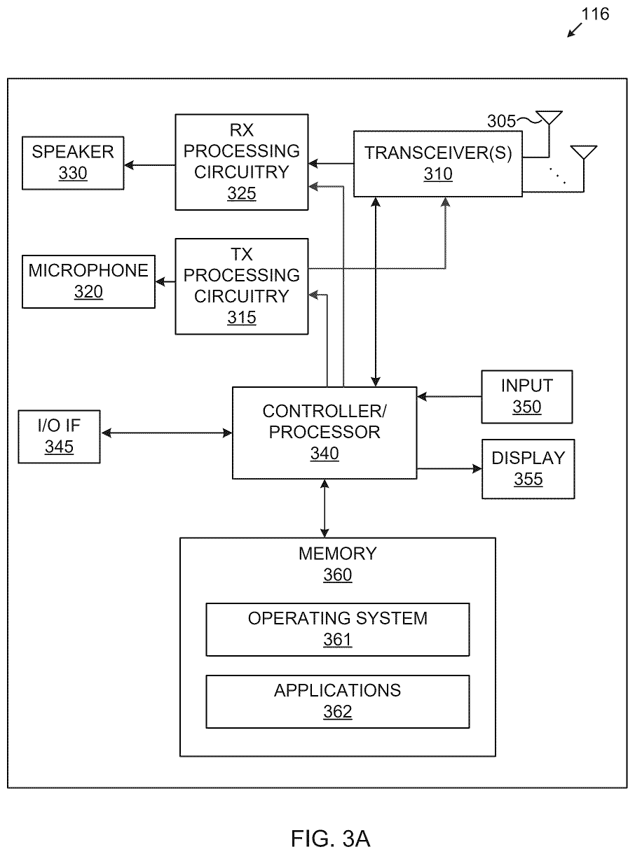

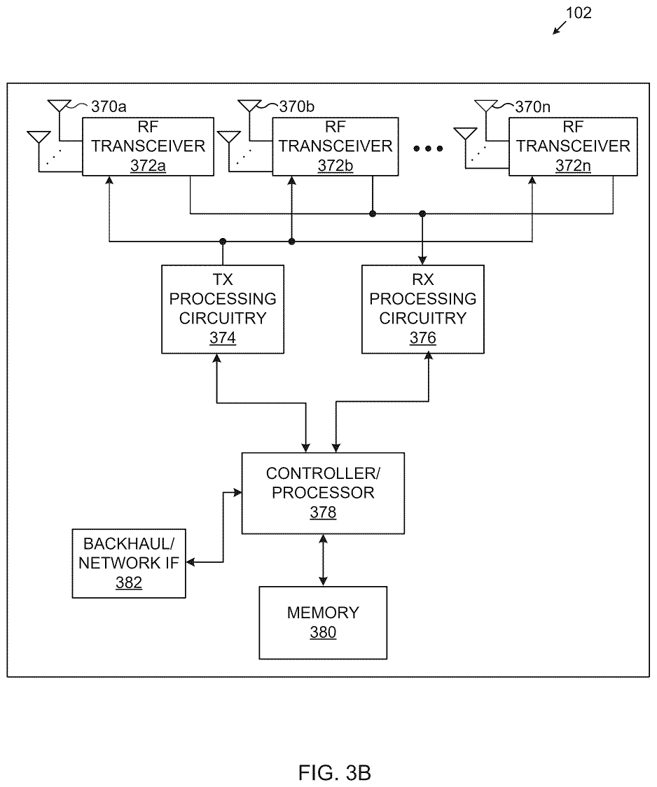

FIG. 3A illustrates an example UE 116 according to the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of the present disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a processor 340, an input/output (I/O) interface 345, an input 350, a display 355, and a memory 360. The memory 360 includes an operating system (OS) program 361 and one or more applications 362.

The RF transceiver 310 receives, from the antenna 305, an incoming RF signal transmitted by a gNB of the wireless network 100 of FIG. 1. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS program 361 stored in the memory 360 in order to control the overall operation of the UE 116. For example, processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS program 361 or in response to signals received from gNBs or an operator. The processor 340 is also coupled to the I/O interface 345, which provides the UE 116 with the ability to connect to other devices such as laptop computers and handheld computers. The I/O interface 345 is the communication path between these accessories and the processor 340.

The processor 340 is also coupled to the input 350 (e.g., keypad, touchscreen, button etc.) and the display 355. The operator of the UE 116 can use the input 350 to enter data into the UE 116. The display 355 can be a liquid crystal display or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3A illustrates one example of UE 116, various changes can be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3A illustrates the UE 116 configured as a mobile telephone or smartphone, UEs could be configured to operate as other types of mobile or stationary devices.

FIG. 3B illustrates an example gNB (base station) 102 according to the present disclosure. The embodiment of the gNB 102 shown in FIG. 3B is for illustration only, and other gNBs of FIG. 1 could have the same or similar configuration. However, gNBs come in a wide variety of configurations, and FIG. 3B does not limit the scope of the present disclosure to any particular implementation of a gNB. The gNB 101 and the gNB 103 can include the same or similar structure as the gNB 102.

As shown in FIG. 3B, the gNB 102 includes multiple antennas 370a-370n, multiple RF transceivers 372 a-372 n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of forward channel signals and the transmission of reverse channel signals by the RF transceivers 372a-372n, the RX processing circuitry 376, and the TX processing circuitry 374 in accordance with well-known principles. The controller/processor 378 could support additional functions as well, such as more advanced wireless communication functions. In some embodiments, the controller/processor 378 includes at least one microprocessor or microcontroller.

The controller/processor 378 is also capable of executing programs and other processes resident in the memory 380, such as an OS. The controller/processor 378 is also capable of utilizing beam configurations in JPTAs described in embodiments of the present disclosure. In some embodiments, the controller/processor 378 supports communications between entities. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The backhaul or network interface 382 could support communications over any suitable wired or wireless connection(s). For example, when the gNB 102 is implemented as part of a cellular communication system (such as one supporting 5G or new radio access technology or NR, LTE, or LTE-A), the backhaul or network interface 382 could allow the gNB 102 to communicate with other gNBs over a wired or wireless backhaul connection. When the gNB 102 is implemented as an access point, the backhaul or network interface 382 could allow the gNB 102 to communicate over a wired or wireless local area network or over a wired or wireless connection to a larger network (such as the Internet). The backhaul or network interface 382 includes any suitable structure supporting communications over a wired or wireless connection, such as an Ethernet or RF transceiver.

The memory 380 is coupled to the controller/processor 378. Part of the memory 380 could include a RAM, and another part of the memory 380 could include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

Although FIG. 3B illustrates one example of a gNB 102, various changes can be made to FIG. 3B. For example, the gNB 102 could include any number of each component shown in FIG. 3A. As a particular example, an access point could include a number of backhaul or network interfaces 382, and the controller/processor 378 could support routing functions to route data between different network addresses. As another particular example, while shown as including a single instance of TX processing circuitry 374 and a single instance of RX processing circuitry 376, the gNB 102 could include multiple instances of each (such as one per RF transceiver).

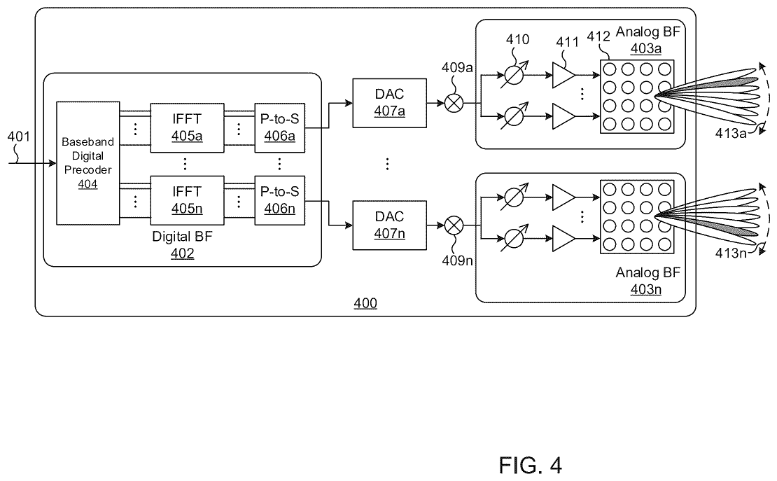

FIG. 4 illustrates an example beamforming architecture that may be used in connection with either hybrid beamforming for O-RAN fronthaul or transmission of control information over O-RAN fronthaul for JPTAs according to embodiments of the present disclosure. The embodiment of the beamforming architecture 400 shown in FIG. 4 is for illustration only. FIG. 4 does not limit the scope of this disclosure to any particular implementation of a beamforming architecture. It is noted that the beamforming architecture 400 or a similar structure may be implemented within any of gNB 101, gNB 102, and/or gNB 103 in FIG. 1. It is noted that the beamforming architecture 400 or a similar structure may be implemented within any of RF transceiver 372a, RF transceiver 372b, and/or RF transceiver 372n in FIG. 3B.

The beamforming architecture 400 receives input signal(s) 401 corresponding to signals to the transmitted. The beamforming architecture 400 includes digital beamforming circuitry 402 and a plurality of instances of analog beamforming circuitry 403 a-403 n. The digital beamforming circuitry 402 includes a baseband digital precoder 404 that receives the input signal(s) 401 and outputs signals for a number of circuitry chains corresponding to the number of CSI-RS ports. Each of those circuitry chains includes an instance of an IFFT block 405a-405n and an instance of a parallel-to-serial block 406a-406 n. The outputs of those circuit chains within the digital beamforming circuitry 402 are passed to a corresponding DAC 407a-407n, the outputs of which are passed via a mixer 409a-409n to one of the instances of analog beamforming circuitry 403a-403n. Each instance of the analog beamforming circuitry 403a-403n includes a plurality of circuit chains including an analog phase shifter 410 and a power amplifier (PA) 411 connected in series to each other and to an array 412 of antenna elements. Each instance of the analog beamforming circuitry 403a-403n transmits on at least one beam within a plurality of beams 413a-413n.

For mm Wave bands, although the number of antenna elements can be larger for a given form factor, the number of CSI-RS ports-which can correspond to the number of digitally precoded ports-tends to be limited due to hardware constraints (such as the feasibility to install a large number of analog-to-digital converters (ADCs)/digital-to-analog converters (DACs) at mmWave frequencies) as illustrated by beamforming architecture 400 in FIG. 4. In this case, one CSI-RS port is mapped onto a large number of antenna elements, which can be controlled by a bank of analog phase shifters 410. One CSI-RS port can then correspond to one sub-array producing a narrow analog beam through analog beamforming 403a-403n. This analog beam can be configured to sweep across a wider range of angles (encompassed by beams 413a, beams 413n, etc.) by varying the phase shifter bank across symbols or subframes or slots (where a subframe or a slot comprises a collection of symbols and/or can comprise a transmission time interval (TTI)). The number of sub-arrays (equal to the number of RF chains) is the same as the number of CSI-RS ports NCSI-PORT. The digital beamforming circuitry 402 performs a linear combination across NCSI-PORT analog beams to further increase precoding gain. While analog beams are wideband (hence not frequency-selective), digital precoding can be varied across frequency sub-bands or resource blocks.

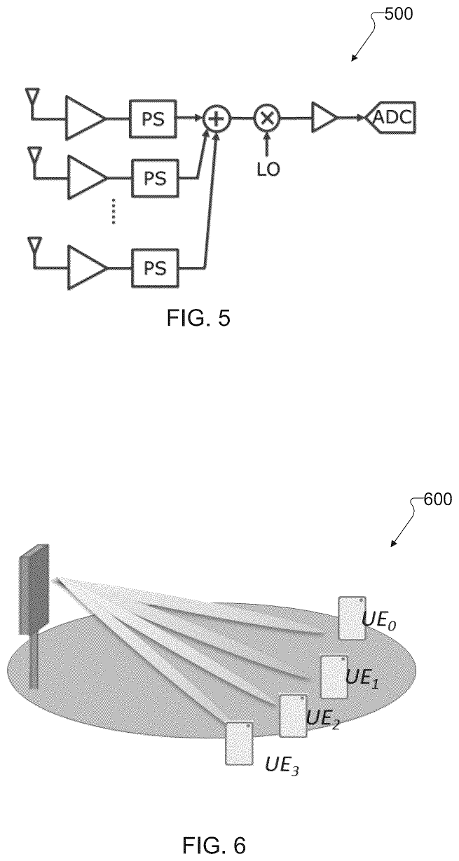

FIG. 5 illustrates a diagram of an example phase-shifter based frequency-flat hybrid beamforming 500 according to embodiments of the present disclosure.

With reference to FIG. 5, some approaches can use a phase-shifter array or a combination of phase-shifters and switches to connect the large antenna array to a few of RF chains.

For example, with reference to FIG. 4, the case of hybrid beamforming at a BS with a single RF chain, i.e., R=1, is evaluated. However, with reference to FIG. 5, some approaches can use a phase-shifter array or a combination of phase-shifters and switches to connect the large antenna array to a few of RF chains.

FIG. 6 illustrates an example of a JPTA beamforming 600 on a beam set according to various embodiments of the present disclosure. For example, the JPTA beamforming 600 may be performed by the BS 102 in the network 101. The JPTA beamforming 600 is for illustration only and other embodiments can be used without departing from the scope of the present disclosure.

In FIG. 6, data is received by UE₀-UE₄ using analog beams. Note that this is just an illustrative example, the network 101 may have 10s or 100s of beams. For the JPTA operation, UEs located at the cell edge have a greater chance of UL transmission in the time domain. The UE can thus transmit multiple replicas of the physical uplink control channel (PUCCH) and/or physical uplink shared channel (PUSCH) packets, which boosts the effective signal to interference and noise ratio (SINR) and thus facilitates the decoding at the BS. The total time-frequency radio resource assigned to cell edge UE can be the same between analog and JPTA beamforming. However, the UE in the JPTA operation can deliver more energy to the BS because of a longer uplink transmission duration. The result of JPTA beamforming being applied to the UEs enable the UL signals to be received simultaneously in a single UL slot.

Embodiments of the present disclosure recognize that not all UL channels/signals may require coverage enhancement via JPTA operation. Therefore, in various embodiments, the gNB applies JPTA to a subset of UL channels/signals transmitted by the UEs experiencing cell edge condition.

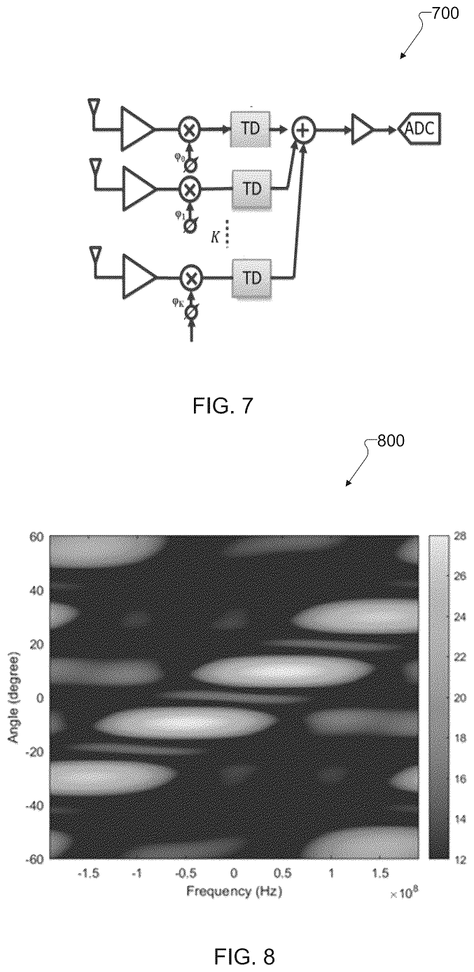

FIG. 7 illustrates a diagram of an example JPTA circuit 700 according to embodiments of the present disclosure. For example, the JPTA circuit 700 may be implemented in the BS 102. This example is for illustration only and other embodiments can be used without departing from the scope of the presence disclosure.

As noted above, JPTA beamforming is an alternative to frequency-flat hybrid beamforming. Note that, here, frequency-dependent beamforming can refer to a technique where different components of the input signal may encounter a differently shaped analog beam based on their frequency. To this end, with reference to FIG. 7, delay elements are utilized in addition to the common phase shifters to create the desired frequency-dependent beam.

By tuning the delay elements and phase shifters, different frequency-dependent beams can be designed. FIG. 8 illustrates an example of a JPTA beam pattern 800 is for a 2D beam pattern for JPTA discrete-angle beam according to embodiments of the present disclosure. The example JPTA beam pattern 800 is for a 2D beam pattern for JPTA discrete-angle beam, where the angles in [−30, −15, 15, 30] are associated with distinct bundles of subcarriers that provide high beam gain. In this case, the BS designs the JPTA to maximize the beam gain for UEs at different angles over distinct continuous sets of subcarriers.

In contrast to phased-array beamforming, UEs at different angles can be served at the same over distinct bundles of sub-carriers without the need for beam sweeping. For example, UEs at [−30, −15, 15, 30] can be simultaneously served over the corresponding subcarrier (i.e., frequency sub-bands). As a result, every UE has access to the channel, which can be exploited for different purposes including fast beam-training, uplink coverage extension, and mobility enhancement.

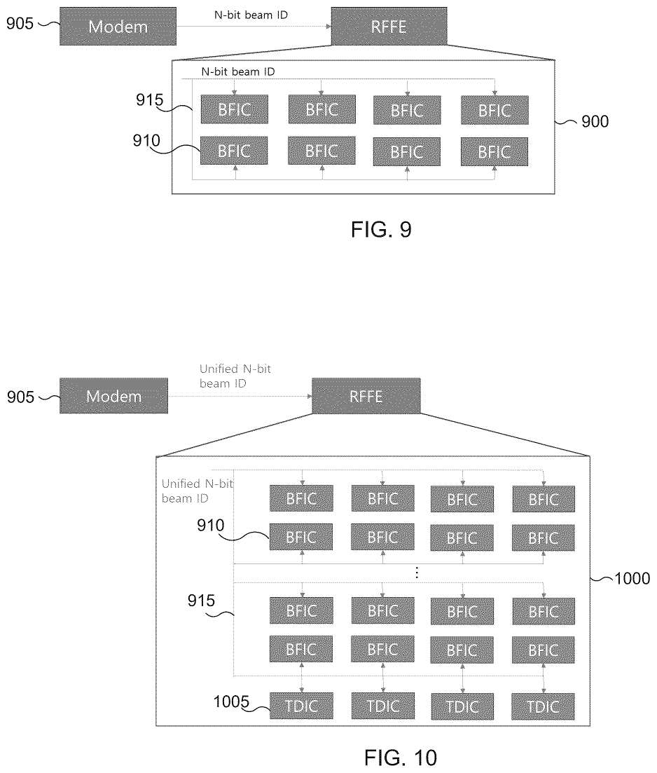

FIG. 9 illustrates an example radio frequency front end interface (RFEE) 900 used in phase-array beamforming according to embodiments of the present disclosure. The embodiment of the RFEE 900 shown in FIG. 9 is for illustration only. Other embodiments of the RFEE could be used without departing from the scope of this disclosure.

As shown in FIG. 9, the RFEE 900 is electrically connected to a modem 905. The RFEE 900 includes one or more beamforming ICs (BFICs) 910. In the architecture used for phase-array beamforming, the BFICs 910 are used to control the phase shifters. Each of the BFICs 910 are connected to a set of phase shifters. A set of phase shifters includes at least one phase shifter. The BS 102 is equipped with relatively large antenna arrays to compensate for the large pathloss in high frequency bands, e.g., mmWave, yielding beams with narrow coverage angle (beam width).

The BS 102 may be constructed with an access unit (AU), which brings together radio, antenna and baseband (L2 scheduler and L1 modem) into one compact box. In another embodiments, the BS 102 may be constructed according to Open-RAN 7-2x architecture, which splits RAN functions between high-PHY (H-PHY) and low-PHY (L-PHY) and L2 and H-PHY modem resides in a distributed unit or a digital unit (DU), and L-PHY, radio and antenna functions are implemented in a radio unit (RU). To provide coverage for the whole sector, the BS 102 stores a beam codebook, where each codeword corresponds to a beam pointing in a certain direction. The corresponding beam is indicated from the modem 905 to the RFEE 900 through an N-bit beam ID as shown in FIG. 9. The interface from modem to RFEE can be an internal one within an AU, or through fronthaul 7-2x interface.

The N-bit beam ID is provided (indicated) to the BFICs 910 via a configuration line 915. The BFICs 910 use the N-bit beam ID to map the ID to the corresponding phase values for the phase shifters. The mapping is done based on a lookup table stored in a memory of BFICs 910. While large codebooks provide larger number of beams enhancing the BS coverage, they may require larger memory at the BFICs 910 and larger bit width for the beam indication. The ideal number of beams that are to be stored is a function of the memory constraints at the BFICs 910, the number of antenna elements at the BS 102, as well as the desired coverage of the BS 102.

As shown in FIG. 7, a BS capable of JPTA beamforming has additional delay units that may need to be configured to realize different JPTA beams. Hence, while the codebook in the phased-array contains codewords mapped to the phases, a codeword in JPTA may need to contain delay values for the TD elements as well. The beam configuration process described earlier with reference to FIG. 9 may need to be updated for JPTA beamforming. This has implications on the size of beam codebook and memory constrains at the BFICs 910 as well as the bit width of the N-bit beam ID.

While the disclosed technology describes a cellular network where the JPTA beam is designed at the BS side, it is not limited to this application. The disclosed technology can be applied to other systems such as WiFi as well as designing beams at the UE side.

FIG. 10 illustrates an example RFEE 1000 used in JPTA beamforming according to embodiments of the present disclosure. The embodiment of the RFEE 1000 shown in FIG. 10 is for illustration only. Other embodiments of the RFEE 1000 could be used without departing from the scope of this disclosure.

As shown in FIG. 10, in JPTA the RFEE 1000 further includes one or more TDICs 1005. As noted above, in the architecture used for JPTA beamforming, the TDICs 1005 are used to control time delay units. Each of the TDICs 1005 are connected to a set of time delay units. Each set of time delay units includes at least one time delay unit.

As shown in FIG. 10, the N-bit beam ID (a unified N-bit beam ID) is used to indicate the JPTA beam from the modem 905 to the RFEE 1000. The N-bit ID is provided to both the BFICs 910 and the TDICs 1005 by the modem 905 via the configuration line 915. The BFICs 910 configure the phase shift generated by a corresponding the set of phase shifters. Each of the TDICs 1005 configure the time delay generated by a corresponding set of time delay units. The BFICs 910 and the TDICs 1005 have a lookup table (see Table 1 below) stored in their memory that includes up to 2^{N} beam IDs. N is an integer greater than or equal to 0.

In the BFICs 910, each N-bit beam ID corresponds to N_{PS} phase values. In the TDICs 1005, each N-bit beam ID corresponds to N_{TD} delay values. Hence, the memory size in each of the BFICs 910 is equal 2^{N} multiplied by N_{PS} phase values. The memory size of each of the TDICs 1005 is equal to 2^{N} multiplied by N_{TD} delay values. The final memory sizes in bits depends on the quantization levels and range of the delay and phase values. In one example, for phase shift values 6-bits in length, the memory requirement (in bits) in each of the BFICs 910 may be equal to 6 multiplied by 2^{N} and N_{PS}, and the memory requirement of each of the TDICs 1005 (in bits) may be equal to 20 multiplied by 2^{N} and N_{TD} assuming 20 predetermined delay values, e.g., up to 9.5 ns max delay with 0.5 ns delay step size.

An example is shown in Table 1, where J_{bits,PS} is used to indicate the number of bits needed to represent each phase value. J_{bits,TD} is used to indicate the number of bits needed to represent each time delay value. The phase portion of the table is used by the BFICs 910 to determine a phase delay value, and the time delay portion is used by each of the TDICs 1005 to determine a time delay value based on the beam ID.

TABLE 1

| | | | | | | |
|---|---|---|---|---|---|---|
| Beam | | | | | | |
| ID | P₁ | . . . | P_{N}_{_{PS}} | D₁ | . . . | D_{N}_{_{TD}} |

| | | | | |
|---|---|---|---|---|
| 1 | J_{bits, PS} | J_{bits, PS} | J_{bits, TD} | J_{bits, TD} |
| | bits value | bits value | bits value | bits value |
| . . . | | | | |
| 2^{N} | J_{bits, PS} | J_{bits, PS} | J_{bits, TD} | J_{bits, TD} |
| | bits value | bits value | bits value | bits value |

However, while the RFEE 1000 shown in FIG. 10 provides a direct extension for the phased-array beam configuration, in some examples, the memory size of each of the BFICs 910 and the TDICs 1005 can be large.

In one example design, the BS 102 has a set of beams, e.g., 160 beams, that can be used to serve the UEs. For example purposes only, assume that the BS 102 knows the best beam for each UE to be scheduled, which can be done using CSI-RS beam measurement reporting with JPTA turned off. A design parameter for JPTA is the number of UEs/beams that can be supported simultaneously, e.g., in FIG. 8, 4 beams are supported. For 3D JPTA, which refers to the hardware (HW) architecture where each antenna element is connected through a dedicated phase shifter and a dedicated delay element, the total number of beam combinations would be equal to 1604 (655360000), which is the same as the number of codewords that may need to be stored in the BFICs 910 and the TDICs 1005. Correspondingly, 30-bits may need to be used to indicate the beam ID. For memory-constrained BFICs 910 and/or TDICs 1005, embodiments of the present disclosure provide different approaches to lower this memory requirement.

In one or more embodiments, azimuth-only JPTA can be used. For Azimuth-only JPTA, each column of antenna elements would be connected through a dedicated delay unit, reducing the number of delay elements and simplifying the hardware at the price of scheduling restrictions. In azimuth-only JPTA, only UEs on the save elevation beam, i.e., elevation angle, can be simultaneously scheduling, reducing the JPTA scheduling opportunity. As a side effect, the number of beam combinations that may need to be accounted for is also reduced. Following the same example above, the number of codewords at the TDICs 1005 is reduced to 655360 with 20-bit beam IDs.

In one or more embodiments, the beam where JPTA is enabled can be restricted. Here, the beam combinations that may need to be supported by JPTA can be restricted to the most common beam combinations based on historical and site-specific data.

In one or more embodiments, contiguous SB allocation can be used. Restricting the SB allocation to be contiguous for each beam reduces the codebook size. For example, assume four SB case with 3 beams. Instead of assigning SB 1 and SB 3 for beam 1 and SB 2 and SB 4 for beam 2, SB 1 and SB 2 can be assigned to beam 1 and SB 3 and SB 4 to beam 2, or vice versa.

In one or more embodiments, beam sorting can be used. Beam sorting includes assigning the SBs are assigned to the beams in the order of their angle-of-departure/arrival (AoD/AoA) monotonically.

It is understood that any of one or combinations of embodiments described herein can be used.

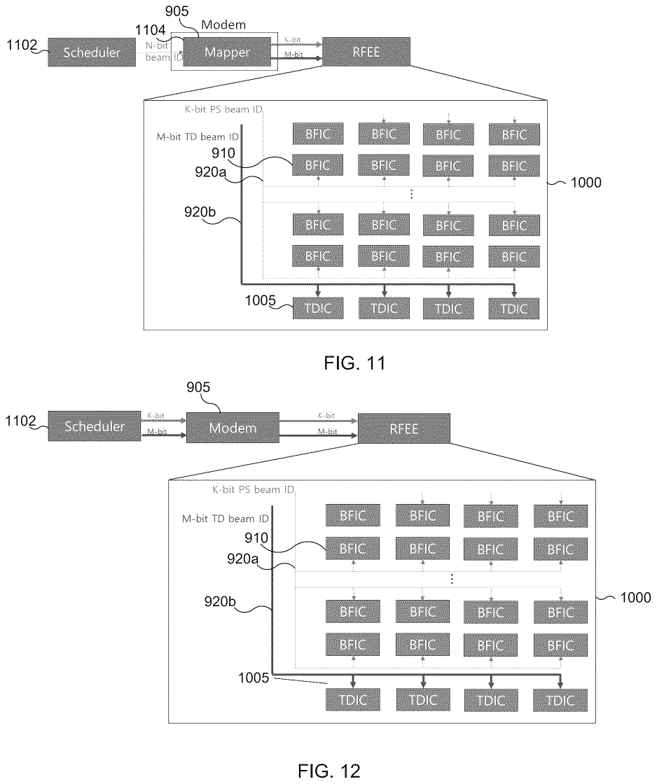

FIG. 11 illustrates an example RFEE 1000 used in JPTA beamforming according to embodiments of the present disclosure. The embodiment of the RFEE 1000 shown in FIG. 10 is for illustration only. Other embodiments of the RFEE could be used without departing from the scope of this disclosure.

As shown in FIG. 11, the memory requirement in the BFICs 910 and the TDICs can be further reduced by transmitting different beam IDs to the BFICs 910 and the TDICs 1005. The RFEE 1000 is further electrically connected to a mapper 1104 within the modem 905. The mapper 1104 receives the N-bit beam ID having a length of N from a scheduler 1102. The mapper 1104 then generates a K-bit phase shift beam ID (K-bit PS beam ID) and a M-bit time delay beam ID (M-bit PS beam ID) based on the received N-bit beam ID. The mapper 1104 then provides the K-bit PS beam ID to each of the BFICs 910 via a configuration line 920a and the M-bit PS beam ID to each of the TDICs 1005 via a configuration line 920b. Here, instead of the BFICs 910 and the TDICs each storing the same lookup table (e.g., Table 1), the BFICs 910 and the TDICs 1005 each store different lookup tables. The BFICs 910 store Table 2, shown below, which is used to map the K-bit PS beam ID to a phase value. The K-bit PS beam ID is represented as 2^{K}, where K is an integer greater than or equal 0. The BFICs 910 map the K-bit PS beam ID to a phase shift value using Table 2 in the similar manner described with respect to Table 1 above.

The TDICs 1005 store Table 3, shown below, is used to map the M-bit PS beam ID to time delay values. The M-bit PS beam ID is represented as 2^{M}, where M is an integer greater than or equal 0. The TDICs 1005 map the M-bit PS beam ID to a time delay value in the same manner described with respect to Table 1 above.

TABLE 2

| | | | |
|---|---|---|---|
| K-bit PS | | | |
| beam ID | P₁ | . . . | P_{N}_{_{PS}} |

| | | |
|---|---|---|
| 1 | J_{bits, PS} bits value | J_{bits, PS} bits value |
| . . . | | |
| 2^{K} | J_{bits, PS} bits value | J_{bits, PS} bits value |

TABLE 3

| | | | |
|---|---|---|---|
| M-bit PS | | | |
| beam ID | D₁ | . . . | D_{N}_{_{TD}} |

| | | |
|---|---|---|
| 1 | J_{bits, TD} bits value | J_{bits, TD} bits value |
| . . . | | |
| 2^{M} | J_{bits, TD} bits value | J_{bits, TD} bits value |

Here, the delay values could be common for different JPTA beams, and the phase values could be common for different JPTA beams. Hence, K and M are expected to be less than N. For example, for azimuth-only JPTA, the delay values for a fixed set of azimuth angles can be the same for different elevation angles, which can significantly reduce the memory size requirement at the TDICs 1005. As noted above, for a codebook with 160 beams (10 rows with 16 columns), the number of beam combinations without scheduling restrictions can be as high as 655360 corresponding to a 20-bit beam ID. However, by generating the K-bit PS beam ID and the M-bit PS beam ID from the beam ID only 16*16*16*16=65536 codewords may need to be stored at the TDICs 1005 indicated by a 16-bit M-bit PS beam ID. Furthermore, the codebook stored in the TDICs 1005 can be further optimized to keep only unique codewords, which can further reduce the values of M.

In one or more embodiments, the K-bit PS beam ID and the ID beam IDs can be provided simultaneously or in parallel to the respective BFICs 910 and TDICs 1005. Although the M-bit PS beam IDs and the BFICs are shown as being through two dedicated configuration lines, other variations are also possible. For example, a single delay line can be used to provide the K-bit PS beam ID and the M-bit PS beam ID sequentially, reducing memory requirements without requiring a separate configuration line at the expense of higher latency in the beam configuration.

FIG. 12 illustrates an example RFEE 1000 used in JPTA beamforming according to embodiments of the present disclosure. The embodiment of the RFEE 1000 shown in FIG. 12 is for illustration only. Other embodiments of the RFEE could be used without departing from the scope of this disclosure.

As shown in FIG. 12, the modem 905 can receive the K-bit PS beam ID and the M-bit TD beam ID from the scheduler 1102. The modem 905 then provides the K-bit PS beam ID and the M-bit TD beam ID to the BFICs 910 and the TDICs 1005 via the configuration line 920a and the configuration line 920b, respectively.

As described above, the codebook(s) are designed offline and stored at the RFEE 1000. The modem 905 selects a beam out of the available ones to point the beam in a certain direction. On the other hand, the beam can be designed online and then directly provide the phase values (and delay values) to the RFEE 1000 to configure the phase shifters (and delay elements).

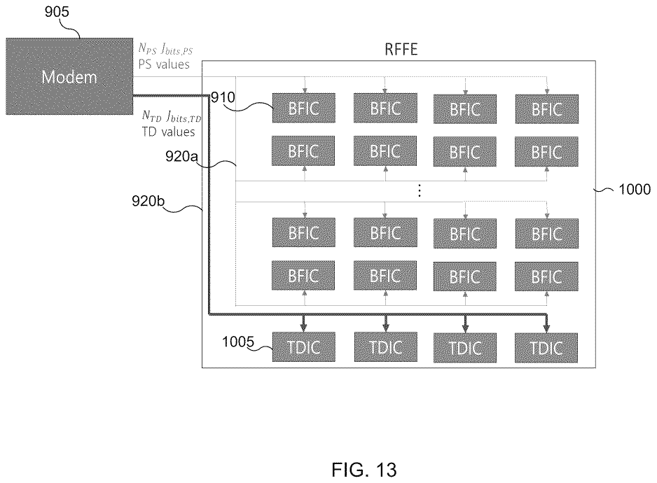

FIG. 13 illustrates an example RFEE 1000 used in JPTA beamforming according to embodiments of the present disclosure. The embodiment of the RFEE 1000 shown in FIG. 13 is for illustration only. Other embodiments of the RFEE could be used without departing from the scope of this disclosure.

As shown in FIG. 13, the modem 905 directly generates and provides the delay and phase values to the BFICs 910 and TDICs 1005. This can eliminate the need for internal memory to store a codebook at the BFICs 910 and TDICs 1005 and provides more flexibly for scheduling and beamforming, it may require fast scheduling and beamforming algorithms as well as a fast hardware interface to configure the BFICs 910 and TDICs 1005. This may allow for online beam design and configuration. The number of bits needed to configure TDICs and BFICs for each beam configuration depends on the number of delay elements, phase shifters, and the number of bits for each delay value and phase value. As noted above, the phase shifters are controlled by J_{bits,PS} bits and the time delay units by J_{bits,TD} bits, respectively. The modem 905 can configure the BFICs 910 and TDICs 1005 in parallel or sequentially, which reduces the bit width for the configuring the ICs at the expense of delay. Another alternative is to use a unified line to configure the BFICs 910 and TDICs 1005, which simplifies the hardware at the expense of more delay in configuring the beam or bit width requirement.

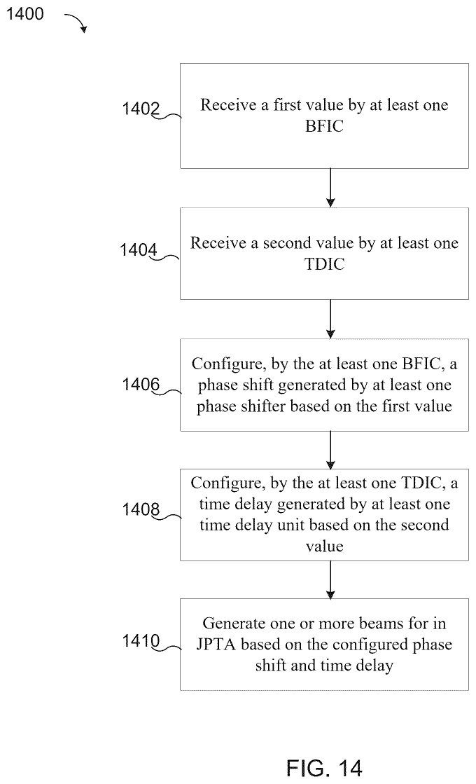

FIG. 14 illustrates a flowchart for an example method 1400 wherein a BS performs JPTA according to an embodiment of the present disclosure. For example, the method 1400 can be performed by the BS 102.

The method 1400 begins with at least one BFIC receiving a first value (1402) and at least one TDIC receiving a second value (1404). For example, at least one BFIC of the BFICs 910 receives the first value, and at least one TDIC of the TDICs 1005 receives the second value. The first value and the second value can be the same or different values. In one or more embodiments, the first and second values are both the N-bit beam ID and are generated and provided by the modem 905, as shown in FIG. 10. In one or more embodiments, the first value is a first beam ID (the K-bit PS beam ID), and the second value is a second beam ID (the M-bit PS beam ID), as shown in FIGS. 11 and 12. As shown in FIG. 11, the K-bit PS beam ID and the M-bit TD ID are generated and provided by the modem 905, via the mapper 1104, based on receipt of the N-bit beam ID from the scheduler 1102. As shown in FIG. 12, the K-bit PS beam ID and the M-bit TD ID are generated by the scheduler 1102 and provided by the modem 905 to the at least one BFIC and the at least one TDIC, respectively. In one or more embodiments, the first value a phase shift value and the second value is a delay value directly determined and provided by the modem 905, as shown in FIG. 13. Next the at least one BFIC configures a phase shift generated by at least one phase shifter based on the first value (1406) and the at least one TDIC configures a time delay generated by at least one time delay unit based on the second value (1408). Next, the BS generates one or more beams for in JPTAs based on the configured phase shift and time delay (1410).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for operating a base station (BS), the method comprising:
receiving a first value by at least one beamforming integrated circuit (BFIC);
receiving a second value by at least one time delay integrated circuit (TDIC);
configuring, by the at least one BFIC, a phase shift generated by at least one phase shifter based on the first value;
configuring, by the at least one TDIC, a time delay generated by at least one time delay unit based on the second value; and
generating one or more beams for joint time phased arrays (JPTAs) based on the configured phase shift and time delay.

2. The method of claim 1, wherein the first value and the second value are identical and comprise a unified beam identification (ID).

3. The method of claim 1, wherein:
the first value comprises a first beam identification (ID),
the second value comprises a second beam ID, and
the first beam ID and the second beam ID are different.

4. The method of claim 1, wherein:
the first value comprises a phase shift, and
the second value comprises a time delay.

5. The method of claim 1, wherein:
the at least one phase shifter comprises a first set of phase shifters configured by a first BFIC and a second set of phase shifters configured by a second BFIC,
the first set of phase shifters are configured by the first BFIC to generate a first phase shift based on the first value, and
the second set of phase shifters are configured by the second BFIC to generate a second phase shift based on the first value.

6. The method of claim 1, wherein:
the at least one time delay unit comprises a first set of time delay units configured by a first TDIC and a second set of time delay units configured by a second TDIC,
the first set of time delay units are configured by the first TDIC to generate a first time delay based on the second value, and
the second set of time delay units are configured by the second TDIC to generate a second time delay based on the second value.

7. The method of claim 1, wherein the first value and the second value are received sequentially or in parallel.

8. A base station (BS), comprising:
at least one beamforming integrated circuit (BFIC) configured to receive a first value, and configure a phase shift generated by at least one phase shifter based on the first value; and
at least one time delay integrated circuit (TDIC) configured to receive a second value, and configure a time delay generated by at least one time delay unit based on the second value,
wherein the BS is configured to generate one or more beams for in joint time phased arrays (JPTAs) based on the configured phase shift and time delay.

9. The BS of claim 8, wherein the first value and the second value are identical and comprise a beam identification (ID).

10. The BS of claim 8, wherein:
the first value comprises a first beam identification (ID),
the second value comprises a second beam ID, and
the first beam ID and the second beam ID are different.

11. The BS of claim 8, wherein:
the first value comprises a phase shift, and
the second value comprises a time delay.

12. The BS of claim 8, wherein:
the at least one phase shifter comprises a first set of phase shifters configured by a first BFIC and a second set of phase shifters configured by a second BFIC,
the first set of phase shifters are configured by the first BFIC to generate a first phase shift based on the first value, and
the second set of phase shifters are configured by the second BFIC to generate a second phase shift based on the first value.

13. The BS of claim 8, wherein:
the at least one time delay unit comprises a first set of time delay units configured by a first TDIC and a second set of time delay units configured by a second TDIC,
the first set of time delay units are configured by the first TDIC to generate a first time delay based on the second value, and
the second set of time delay units are configured by the second TDIC to generate a second time delay based on the second value.

14. The BS of claim 8, wherein the first value and the second value are received sequentially or in parallel.

15. A non-transitory computer readable medium comprising program code that, when executed by processing circuitry of a base station (BS), causes the BS to:
receive a first value by at least one beamforming integrated circuit (BFIC);
receive a second value by at least one time delay integrated circuit (TDIC);
configure, by the at least one BFIC, a phase shift generated by at least one phase shifter based on the first value;
configure, by the at least one TDIC, a time delay generated by at least one time delay unit based on the second value; and
generate one or more beams for joint time phased arrays (JPTAs) based on the configured phase shift and time delay.

16. The non-transitory computer readable medium of claim 15, wherein the first value and the second value are identical and comprise a beam identification (ID).

17. The non-transitory computer readable medium of claim 15, wherein:
the first value comprises a first beam identification (ID),
the second value comprises a second beam ID, and
the first beam ID and the second beam ID are different.

18. The non-transitory computer readable medium of claim 15, wherein:
the first value comprises a phase shift, and
the second value comprises a time delay.

19. The non-transitory computer readable medium of claim 15, wherein:
the at least one phase shifter comprises a first set of phase shifters configured by a first BFIC and a second set of phase shifters configured by a second BFIC,
the first set of phase shifters are configured by the first BFIC to generate a first phase shift based on the first value, and
the second set of phase shifters are configured by the second BFIC to generate a second phase shift based on the first value.

20. The non-transitory computer readable medium of claim 15, wherein:
the at least one time delay unit comprises a first set of time delay units configured by a first TDIC and a second set of time delay units configured by a second TDIC,
the first set of time delay units are configured by the first TDIC to generate a first time delay based on the second value, and
the second set of time delay units are configured by the second TDIC to generate a second time delay based on the second value.
